(19) United States
(12) Patent Application Publication
(10) Pub. No.: US 2022/0366509 A1
(43) Pub. Date: Nov. 17, 2022

(54) TRANSPORTATION USAGE ANALYTICS SYSTEM AND METHOD USING GEOLOCATION

(71) Applicant: State Farm Mutual Automobile Insurance Company, Bloomington, IL (US)

(72) Inventors: Joseph Robert Brannan, Bloomington, IL (US); Ryan Michael Gross, Normal, IL (US); Brian N. Harvey, Bloomington, IL (US)

(21) Appl. No.: 17/876,316

(22) Filed: Jul. 28, 2022

Related U.S. Application Data
(63) Continuation of application No. 16/902,632, filed on Jun. 16, 2020.
(60) Provisional application No. 62/866,351, filed on Jun. 25, 2019.

(51) Int. Cl. G06Q 40/08

(52) U.S. Cl. CPC G06Q 40/08

(57) ABSTRACT

The present embodiments may relate to systems for user mobility data analytics for a usage-based insurance platform. For instance, a user mobility analytics computing device may be configured to: (1) receive, from a user device, telematics data; (2) identify, from the telematics data, a plurality of trips; (3) identify, for each of the plurality of trips, a transportation mode based upon the telematics data; (4) build a trip database including the plurality of trips and trip data associated with each trip, the trip data including the transportation mode; (5) parse the trip data in the trip database to aggregate trip data associated with a particular transportation mode; (6) retrieve insurance policy data associated with an insurance policy and including a coverage type and a coverage amount; and (7) calculate an insurance premium based upon the aggregated trip data for the particular transportation mode and the insurance policy data.

### CROSS-REFERENCE TO RELATED APPLICATIONS

This application is a continuation of, and claims the benefit of priority to, U.S. patent application Ser. No. 16/902,632, filed Jun. 16, 2020, which claims the benefit to U.S. Provisional Patent Application No. 62/866,351, filed Jun. 25, 2019, the entire contents and disclosures of which are herein incorporated by reference in their entirety.

### FIELD OF THE INVENTION

The present disclosure relates to transportation usage analytics and, more particularly, to systems and methods for collecting and analyzing user mobility data to generate transportation usage analytics.

### BACKGROUND

Individuals have many options for traveling from place to place. For example, an individual may choose between different modes of transportation. Further, each mode of transportation may be, for example, private (e.g., a private automobile or bicycle), public (e.g., a municipal bus or train), or shared (e.g., rideshare or bike share).

Mobile devices carried by individuals may be sources of data with respect to the individual's usage of these forms of transportation. Certain forms of transportation may be associated with a website or mobile application that can be used to access and/or pay for the transportation. For example, rideshare and bike share programs often include a mobile app used to hail a ride or unlock a bike, respectively, and pay once the ride is complete. Public transportation systems often provide mobile apps that allow a user to, for example, purchase and/or display tickets. In addition to apps, mobile devices often include components such as a global positioning system (GPS) device or an accelerometer, which may be used to generate data.

Such data collectively may be useful for various purposes. However, conventional systems may not provide a means of collecting transportation usage data and/or analyzing such data.

### BRIEF SUMMARY

The present embodiments may relate to, inter alia, systems and methods for collection user mobility and/or transportation data analytics. A platform may collect and analyze transportation usage data associated with an individual in order to assess an individual's transportation behavior, provide more individualized insurance coverage based upon the individual's specific transportation behavior, and/or provide individualized coverage options or incentives based upon the individual's transportation behavior.

The systems and methods may also include building a trip database including a plurality of trips of a user and trip data associated with each of the plurality of trips, and analyzing the trip data to determine the user's transportation behavior. The systems and methods may further include providing a usage-based insurance platform that includes an interface with which the user may interact. For example, the user may activate or deactivate insurances, and/or set rules under which insurance policies will automatically activate or deactivate, using the interface.

In one aspect, a user mobility analytics (UMA) computing device including at least one processor in communication with a memory device is provided. The processor may be configured to: (1) receive, from a user device, telematics data corresponding to a user; (2) identify, from the telematics data, a plurality of trips of the user; (3) identify, for each of the plurality of trips, a transportation mode based upon the telematics data; (4) build a trip database including the plurality of trips and trip data associated with each trip, the trip data including the transportation mode; (5) parse the trip data in the trip database to aggregate trip data associated with a particular transportation mode; (6) retrieve insurance policy data associated with an insurance policy of the user, the insurance policy data including a coverage type and a coverage amount; and/or (7) calculate an insurance premium based upon the aggregated trip data for the particular transportation mode and the insurance policy data. The UMA computing device may include additional, less, or alternate functionality, including that discussed elsewhere herein.

In another aspect, a computer-implemented method for user mobility analytics is provided. The computer-implemented method may be performed by a user mobility analytics (UMA) computing device that includes at least one processor in communication with a memory device. The computer-implemented method may include: (1) receiving, by the UMA computing device, from a user device, telematics data corresponding to a user; (2) identifying, by the UMA computing device, from the telematics data, a plurality of trips of the user; (3) identifying, by the UMA computing device, for each of the plurality of trips, a transportation mode based upon the telematics data; (4) building, by the UMA computing device, a trip database including the plurality of trips and trip data associated with each trip, the trip data including the transportation mode; (5) parsing, by the UMA computing device, the trip data in the trip database to aggregate trip data associated with a particular transportation mode; (6) retrieving, by the UMA computing device, insurance policy data associated with an insurance policy of the user, the insurance policy data including a coverage type and a coverage amount; and/or (7) calculating, by the UMA computing device, an insurance premium based upon the aggregated trip data for the particular transportation mode and the insurance policy data. The computer-implemented method may include additional, less, or alternate actions, including that discussed elsewhere herein.

In another aspect, a non-transitory computer-readable media having computer-executable instructions embodied thereon is provided that, when executed by a user mobility analytics (UMA) computing device including a processor in communication with a memory device, may cause the processor to: (1) receive, from a user device, telematics data corresponding to a user; (2) identify, from the telematics data, a plurality of trips of the user; (3) identify, for each of the plurality of trips, a transportation mode based upon the telematics data; (4) build a trip database including the plurality of trips and trip data associated with each trip, the trip data including the transportation mode; (5) parse the trip data in the trip database to aggregate trip data associated with a particular transportation mode; (6) retrieve insurance policy data associated with an insurance policy of the user, the insurance policy data including a coverage type and a coverage amount; and/or (7) calculate an insurance premium based upon the aggregated trip data for the particular transportation mode and the insurance policy data. The instructions may direct additional, less, or alternate functionality, including that discussed elsewhere herein.

In another aspect, a user mobility analytics (UMA) computing device including at least one processor in communication with a memory device is provided. The processor may be configured to: (1) receive, from a user device, a policy activation request message including an activation status of an insurance policy of a user; (2) receive, from a user device, telematics data corresponding to the user; (3) identify, from the telematics data, a plurality of trips of the user; (4) identify, for each of the plurality of trips, a transportation mode based upon the telematics data; (5) build a trip database including the plurality of trips and trip data associated with each trip, the trip data including the transportation mode; (6) parse the trip data in the trip database to aggregate trip data associated with a particular transportation mode; (7) retrieve insurance policy data associated with the insurance policy of the user, the insurance policy data including a coverage type and a coverage amount; and/or (8) calculate an insurance premium based upon the activation status and the aggregated trip data for the particular transportation mode and the insurance policy data. The UMA computing device may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 depicts an exemplary user mobility analytics (UMA) system in accordance with an exemplary embodiment of the present disclosure.

FIG. 2 depicts an exemplary client computing device that may be used with the UMA system illustrated in FIG. 1.

FIG. 3 depicts an exemplary server system that may be used with the UMA system illustrated in FIG. 1.

FIG. 4 illustrates an exemplary computer-implemented method for user mobility analytics in a usage-based insurance (UBI) platform that may be performed using the UMA system illustrated in FIG. 1.

FIG. 5 illustrates an exemplary computer-implemented method for verifying a transportation mode of a trip that may be performed using the UMA system illustrated in FIG. 1.

FIG. 6 illustrates an exemplary computer-implemented method of receiving user input in a UBI platform may be performed using the UMA system illustrated in FIG. 1.

FIG. 7 illustrates an exemplary computer-implemented method of implementing geographic location dependent UBI through a UBI platform that may be performed using the UMA system illustrated in FIG. 1.

FIG. 8 illustrates an exemplary computer-implemented method of providing and verifying the completion of user challenges within a UBI platform that may be performed using the UMA system illustrated in FIG. 1.

FIG. 9 illustrates an exemplary computer-implemented method for activating and deactivating a UBI policy using a UBI platform that may be performed using the UMA system illustrated in FIG. 1.

FIG. 10 illustrates an exemplary computer-implemented method for automatically activating and deactivating a UBI policy based upon a geographic location that may be performed using the UMA system illustrated in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for collecting and generating user mobility and/or transportation data analytics. In some cases, this collected data may be used for a usage-based insurance platform. The systems and methods may include building a trip database including a plurality of trips of a user and trip data associated with each of the plurality of trips, and analyzing the trip data to determine the user's transportation behavior. The systems and methods may further include providing a usage-based insurance platform that includes an interface with which the user may interact. For example, the user may activate or deactivate insurances, and/or set rules under which insurance policies will automatically activate or deactivate, using the interface. In one exemplary embodiment, the process may be performed by a user mobility analytics (“UMA”) computing device.

As described below, the systems and methods described herein include collecting and analyzing telematics data to determine a plurality of trips associated with the user, and generating data associated with the trips. By so doing, the systems and methods are able to determine and quantify the user's transportation behavior, enable an insurer to tailor insurance coverage to the user's particular transportation behavior, provide incentives to the user to engage in safer transportation behavior, and provide an interface with which a user may make changes to the user's insurance coverage.

### Retrieving Telematics Data

The UMA computing device may be configured to collect and analyze telematics data to generate trip data. The UMA computing device may receive telematics data from a user device (e.g., a mobile phone device). For example, a user device may have an application (“app”) installed on the user device (such as a mobile device) that generates telematics data. The app may generate the telematics data based upon data received from sensors onboard the user device (e.g., an accelerometer, a global positioning system (GPS), or a gyroscope). The telematics data may include, for example, a position (e.g., geographic coordinates), a speed, acceleration and deceleration, and/or an orientation of the user device.

The user device may transmit the telematics data to the UMA computing device. In some embodiments, the user device may transmit telematics data continuously to the UMA computing device. Alternatively, the user device may collect telematics data continuously and periodically transmit the telematics data to the UMA computing device in bulk. In certain embodiments, the UMA computing device may additionally or alternatively receive telematics data generated by the user device from third parties. The UMA computing device may store the retrieved telematics data in a database.

The UMA computing device may further retrieve data from third party sources. For example, using the app, the user may provide login information to various user accounts associated with transportation (e.g., rideshare accounts, bike share accounts, public transportation accounts, or travel accounts). The UMA computing device may use the login information to access third party computing devices associated with the various accounts. The UMA computing device may retrieve data from the third party computing devices. For example, the user may take a trip on a rideshare using a rideshare platform or a bicycle using a bicycle share platform. Data corresponding to the trip may be generated by the rideshare platform or bicycle share platform and stored on a third party computing device associated with the rideshare organization. The UMA computing device may retrieve the data from the third party computing device and store in the database.

### Analyzing Retrieved Telematics Data

The UMA computing device may analyze the retrieved telematics data, for example, to identify trips associated with the user and to identify data characterizing each trip. To identify a trip, the UMA computing device may determine when the user is traveling or not traveling. For example, when GPS data indicates the user is remaining in the same location (e.g., within a same building), the UMA computing device may determine the user is not traveling. The UMA computing device may identify trips as periods when the user is traveling. The UMA computing device may store each identified trip in a trip database. The UMA computing device may additionally or alternatively receive trips and associated data from third party sources (e.g., rideshare apps), as described above. Such trips may also be stored in the trip database by the UMA computing device.

The UMA computing device may analyze the telematics data to generate trip data associated with each of the trips in the trip database. The UMA computing device may identify, for example, an origin, a destination, a route, a mileage, a start time, and end time, a duration, and a transportation mode. The transportation mode may include a form of transportation (e.g., automobile, bicycle, bus, or train).

The transportation mode may include additional detail about the particular form. For example, if the form of transportation is an automobile, the transportation mode may indicate whether the automobile is privately owned, rented (e.g., through a traditional car rental or car share), or hired (e.g., through a taxi service, car service, or rideshare). In some embodiments, the UMA computing device may utilize machine learning to generate trip data based upon telematics data. The UMA computing device may store such trip data in the trip database in association with the trip.

The UMA computing device may identify the origin and destination from the telematics data using, for example, geographic coordinates obtained from a GPS. The UMA device may store the raw geographic coordinates as the origin and destination. Further, the UMA computing device may identify particular locations associated with the geographic coordinates. For example, a location where the user typically spends each night may be identified as the user's home.

Additionally, the UMA computing device may retrieve data from, for example, the Internet to identify locations associated with particular geographic coordinates (e.g., a location having particular geographic coordinates is known to correspond to a particular business). Identifying the location enables the UMA computing device to further characterize the trip. For example, a trip having its origin at the user's home and its destination at the user's workplace may be characterized as the user's morning commute. Such a characterization may be stored in the database as trip data associated with the characterized trip.

The UMA computing device may identify the transportation mode from the telematics data. The UMA computing device may distinguish between different transportation modes based upon the telematics data. For example, speed and/or acceleration can be used to distinguish between modes such as walking, bicycling, or travelling by vehicle. The route can be used to distinguish between, for example, using road transportation versus traveling by railroad. In some embodiments, the UMA computing device may utilize machine learning to identify the transportation mode of a trip based upon telematics data.

In some embodiments, the UMA computing device may verify the transportation mode with the user. Upon identifying a trip and a mode of transportation associated with the trip, the UMA computing device may transmit a verification message to the user device and receive a response message from the user device. The user device may display and receive a response input to the verification message from the user through the app. For example, upon identifying a train ride, the UMA computing device may transmit a verification message to the user device asking the user “how was the train ride?” and allowing the user to select between “good,” “OK,” “bad,” or “I did not ride the train.” The user may select a response through the app. If the user indicates that the user did not ride a train, the UMA computing device may, for example, identify a different transportation mode for the trip and/or send another message to the user device asking the user which transportation mode was used.

Verifying the transportation mode enables the UMA computing device to improve its ability to identify a transportation mode for a trip, for example, using machine learning. In some embodiments, the UMA computing device may verify the identified transportation mode until a threshold amount of trip data has been accumulated. The UMA computing device may display, through the app on the user device, an amount of progress in accumulating data until verification is no longer necessary. For example, a point may be awarded for each verification message response by the user, and verification messages may no longer be sent to the user once the user has accumulated a certain number of points. The user's current number of points may be displayed in the app.

In some embodiments, the UMA computing device may determine that the user device is not being used sufficiently for the accumulated telematics data to accurately reflect the user's transportation behavior. For example, the user may not take the user device along with, or may turn the user device off, when traveling. The UMA computing device may display a message via the user device indicating, for example, that services associated with the UMA computing device (e.g., usage-based insurance) may not be available unless sufficient data is collected.

### Usage-Based Insurance Applications of Trip Data

The UMA computing device may analyze trip data for a user to determine an amount of usage of different transportation modes, and identify patterns in the user's transportation behavior. In usage-based insurance (UBI), a premium is calculated based at least in part on an insured user's actual transportation behavior. As such, the analysis of trip data may enable an insurer to provide a UBI policy to the user having a premium and coverage that depend on the user's actual transportation behavior. For example, the UMA computing device may retrieve insurance policy data such as a coverage type and a coverage amount, and calculate a premium for the insurance policy based upon the trip data and insurance policy data.

The UMA computing device may parse the trip data to identify trips associated with a certain transportation mode (e.g., private automobile or rideshare). The UMA computing device may then aggregate the parsed trip data to analyze the user's transportation behavior. For example, the UMA computing device may parse the trip data to identify all trips having a particular transportation mode and aggregate the trips having the same transportation mode to determine, for example, a total amount of time and/or a total mileage for trips having the particular transportation mode.

Determining the total amount of time on trips having the same particular transportation mode enables the UMA computing device to determine an insurance premium for a UBI policy, such as a personal mobility policy (PMP). A PMP is a UBI policy that covers a user for multiple forms of personal transportation utilized by the user. For example, a PMP may cover a user for multiple different transportation modes (e.g., rideshares and bike shares). The premium may depend on, for example, an amount of time spent on the different transportation modes (e.g., 10 cents per minute on a bike share). The premium may further depend on the geographic location of the trip (e.g., 10 cents per minute in a suburban area and 20 cents per minute in an urban area). Additionally, the premium may depend on a total number of trips corresponding to the particular transportation mode (e.g., a travel insurance premium based upon a number of airline trips retrieved from a travel website).

### Identifying Transportation Usage Patterns

The UMA computing device may aggregate trip data for a user to identify patterns in the user's transportation behavior. For example, the UMA computing device may determine the user's preferred transportation mode for different situations (e.g., different times or locations) by determining the total amount of trips having a particular transportation mode in a particular situation. For example, the UMA computing device may determine that the user rides a train to work three days a week and drives the other two days of the week.

In some embodiments, the UMA computing device may use machine learning to identify patterns in the user's transportation behavior and predict future transportation behavior based upon previous trips. Identifying patterns enables a determination of, for example, an amount of risk associated with the user's transportation behavior. Such a determination may be used by the UMA computing device when determining a premium at which to insure the user. For example, the UMA computing device may calculate a discounted premium for a user that engages in safer transportation behavior.

In some embodiments, the UMA computing device may calculate a score corresponding to the amount of risk associated with the user's transportation behavior (e.g., a score that is higher for safer transportation behavior). The score may correspond to a particular trip or be calculated across all the trips taken by the user. For example, the score for each trip may be aggregated into a cumulative score. A user achieving a certain cumulative score may earn prizes (e.g., in-app recognition such as a badge) to incentivize safer transportation behavior.

The UMA computing device may determine that the user has earned such a prize based upon the calculated score. For example, a prize may be earned if the score is above a threshold score or the score falls within a certain percentile with respect to scores of other users.

### Providing a User Interface

The UMA computing device may be configured to provide a user interface enabling the user to interact with the UMA computing device (e.g., using the user device). For example, the UMA computing device may provide a mobile app that can display messages generated by the UMA computing device, enable the user to submit messages and/or other input to the UMA computing device, and/or view information provided by the UMA computing device.

In some embodiments, the user interface may allow the user to view information about their transportation behavior generated by UMA computing device 102. For example, the user may view charts, tables, or graphs breaking down the user's transportation behavior using the app.

In some embodiments, the user interface may enable the user to view information about or make changes to the user's insurance policies. For example, in certain embodiments, the user may activate or deactivate insurance policies, set rules under which insurance policies will automatically activate or deactivate (e.g., geographic zones where policies are activated), and/or make changes to coverage types or amounts using the app. In such embodiments, the user may view the current activation status and/or coverage amount of policies associated with the user.

### Altering Insurance Coverage Using the User Interface

In some embodiments, the UMA computing device may enable a user to make changes to the user's insurance coverage through the app. For example, a user may activate or deactivate coverage, or change a coverage amount. Such changes may be preset to automatically occur under certain conditions, such as when the user is in a certain geographic zone.

The UMA computing device may receive requests to make a change in insurance coverage. The requests may be generated and transmitted by the user device running the app. The requests may include, for example, requests to activate or deactivate a certain type of insurance coverage or to change the amount of coverage. Such requests may further include requests to set up geography-dependent coverage, such as coverage that is only activated in a certain geographic area or changes amount in a certain geographic area. The UMA computing device may calculate an insurance premium that corresponds to the trip data in the trip database and the amount or type of coverage requested by the user.

The coverage can thus be tailored to fit the current needs of the user. For example, a user that only uses rideshares when in a particular city may opt to have a PMP covering rideshares that only becomes active when the user is in the particular city. Because the user does not have personal mobility policy coverage outside the particular city, the UMA computing device determines the premium based only upon trips in the trip database that occurred within the particular city.

In another example, a user may desire increased towing coverage (e.g., 400 miles instead of 50 miles) when traveling through a rural area. The user may request, for example, that the towing coverage automatically increase when the user is in a geographic zone associated with the rural area. The UMA computing device may then determine that a premium associated with increased towing coverage should be charged only when the UMA computing device identifies trips with a location in the rural area (e.g., a route that passes through the rural area).

### Providing and Verifying Completion of User Challenges

In some embodiments, the UMA computing device may enable, for example, an insurance company to provide incentives (e.g., prizes) for engaging in certain transportation behaviors. For example, the UMA computing device, through the user interface, may provide challenges to users (e.g., riding a bicycle a certain number of miles or a certain number of trips), which may be completed to earn a prize (e.g., an insurance discount, free insurance products or other products, in-app badges). The UMA computing device may use trip data in the trip database to determine whether a user has completed a challenge.

The UMA computing device may display challenge offer messages including challenge offers via the user device. The challenge offers may include, for example, a requirement to engage in a certain transportation behavior and a potential prize for completing the challenge. To determine whether a user has met the requirements of the challenge, the UMA computing device may retrieve and analyze trip data in the trip database. For example, to determine that a user has completed a certain number of bicycle trips, the UMA computing device may parse the trip data in the trip database to identify bicycle trips and count the number of identified trips.

In another example, the challenge may be to be in the top 30% of bicycle riders by distance traveled. To determine whether the challenge has been completed, the UMA computing device may calculate an aggregated distance traveled by bike for each user and compare the calculated distances to determine the top 30% of users. If the requirements of the challenge are met, the UMA computing device may determine that the user has completed the challenge and display a challenge completion message via the user device.

The UMA computing device may further be configured to facilitate providing the prize to the user. For example, the UMA computing device may determine that a certain insurance product (e.g., roadside assistance) should be provided to the user, or the UMA computing device may provide an in-app badge to the user through that may be shared through social media.

At least one of the technical problems addressed by this system may include: (i) inability of a computing device to identify trips based upon telematics data; (ii) inability of a computing device to determine transportation mode of a trip based upon telematics data; (iii) inability of a computing device to a usage-based insurance premium based upon telematics data; (iv) inability of a computing device to identify patterns in a user's transportation usage behavior; (v) inability of a computing device to make changes to a usage-based insurance policy based upon a current geographic location of a user (vi); and inability of a computing device to verify completion of a transportation usage challenge offered to a user.

A technical effect of the systems and processes described herein may be achieved by performing at least one of the following steps: (i) receive, from a user device, telematics data corresponding to a user; (ii) identify, from the telematics data, a plurality of trips of the user; (iii) identify, for each of the plurality of trips, a transportation mode based upon the telematics data; (iv) build a trip database including the plurality of trips and trip data associated with each trip, the trip data including the transportation mode; (v) parse the trip data in the trip database to aggregate trip data associated with a particular transportation mode; (vi) retrieve insurance policy data associated with an insurance policy of the user, the insurance policy data including a coverage type and a coverage amount; and (vii) calculate an insurance premium based upon the aggregated trip data for the particular transportation mode and the insurance policy data.

The technical effect achieved by this system may be at least one of: (i) ability of a computing device to identify trips based upon telematics data; (ii) ability of a computing device to determine transportation mode of a trip based upon telematics data; (iii) ability of a computing device to a usage-based insurance premium based upon telematics data; (iv) ability of a computing device to identify patterns in a user's transportation usage behavior; (v) ability of a computing device to make changes to a usage-based insurance policy based upon a current geographic location of a user (vi); and ability of a computing device to verify completion of a transportation usage challenge offered to a user.

### Exemplary User Mobility Analytics System

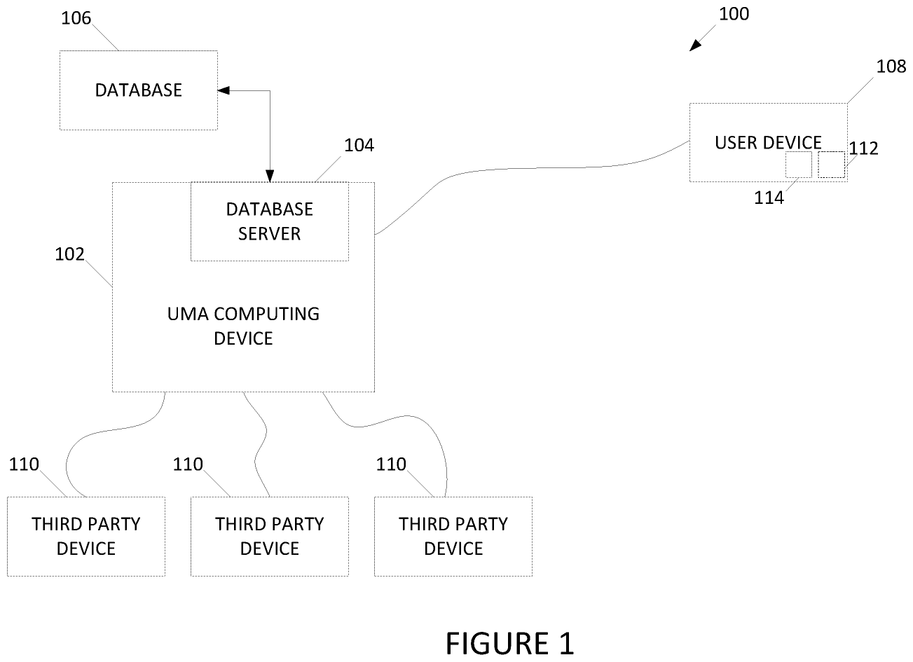

FIG. 1 depicts an exemplary user mobility analytics (“UMA”) system 100. UMA system 100 may include a UMA computing device 102 including a database server 104 and in communication with a trip database 106. UMA computing device 102 may further be in communication with a user device 108 and a plurality of third party computing devices 110. User device 108 may be, for example, a mobile phone device.

The UMA computing device 102 may be configured to collect and analyze telematics data to generate trip data. UMA computing device 102 may receive telematics data from user device 108. For example, a user device may have an application (“app”) 112 installed on the user device that generates telematics data. App 112 may generate the telematics data based upon data received from sensors 114 onboard the user device. Sensors 114 may include, for example, an accelerometer, a global positioning system (GPS), or a gyroscope. The telematics data may include, for example, a position (e.g., geographic coordinates), a speed, acceleration and deceleration, and/or an orientation of the user device.

The user device may transmit the telematics data to UMA computing device 102. In some embodiments, user device 108 may transmit telematics data continuously to the UMA computing device 102. Alternatively, user device 108 may collect telematics data continuously and periodically transmit the telematics data to UMA computing device 102 device in bulk. In certain embodiments, UMA computing device 102 may additionally or alternatively receive telematics data generated by user device 108 from a third party computing device 110 associated with, for example, a telematics entity. UMA computing device 102 may store the retrieved telematics data in a database 106.

UMA computing device 102 may further retrieve data from third party sources. For example, using app 112, the user may provide login information to various user accounts associated with transportation (e.g., rideshare accounts, bike share accounts, public transportation accounts, or travel accounts). UMA computing device 102 may use the login information to access third party computing devices 110 associated with the various accounts.

UMA computing device 102 may retrieve data from the third party computing devices 110. For example, the user may take a trip on a rideshare using a rideshare platform or a bicycle using a bicycle share platform. Data corresponding to the trip may be generated by the rideshare platform or bicycle share platform and stored on a third party computing device 110 associated with the rideshare organization. UMA computing device 102 may retrieve the data from the third party computing device 110 and store in database 106.

UMA computing device 102 may analyze the retrieved telematics data, for example, to identify trips associated with the user and to identify data characterizing each trip. To identify a trip, UMA computing device 102 may determine when the user is traveling or not traveling. For example, when GPS data indicates the user is remaining in the same location (e.g., within a same building), UMA computing device 102 may determine the user is not traveling. UMA computing device 102 device may identify trips as periods when the user is traveling. UMA computing device 102 may store each identified trip in a trip database 106. UMA computing device 102 may additionally or alternatively receive trips and associated data from third party sources (e.g., rideshare apps), as described above. Such trips may also be stored in the trip database 106 by UMA computing device 102.

UMA computing device 102 may analyze the telematics data to generate trip data associated with each of the trips in trip database 106. The UMA computing device may identify, for example, an origin, a destination, a route, a mileage, a start time, and end time, a duration, and a transportation mode. The transportation mode may include a form of transportation (e.g., automobile, bicycle, bus, or train).

The transportation mode may include additional detail about the particular form. For example, if the form of transportation is an automobile, the transportation mode may indicate whether the automobile is privately owned, rented (e.g., through a traditional car rental or car share), or hired (e.g., through a taxi service, car service, or rideshare). In some embodiments, UMA computing device 102 may utilize machine learning to generate trip data based upon telematics data. UMA computing device 102 may store such trip data in trip database 106 in association with the stored trip.

UMA computing device 102 may identify the origin and destination from the telematics data using, for example, geographic coordinates obtained from a GPS. UMA computing device 102 may store the raw geographic coordinates as the origin and destination.

Further, UMA computing device 102 may identify particular locations associated with the geographic coordinates. For example, a location where the user typically spends each night may be identified as the user's home. Additionally, UMA computing device 102 may retrieve data from, for example, the Internet to identify locations associated with particular geographic coordinates (e.g., a location having particular geographic coordinates is known to correspond to a particular business).

Identifying the location enables UMA computing device 102 to further characterize the trip. For example, a trip having its origin at the user's home and its destination at the user's workplace may be characterized as the user's morning commute. Such a characterization may be stored in trip database 106 as trip data associated with the characterized trip.

UMA computing device 102 may identify the transportation mode from the telematics data. UMA computing device 102 may distinguish between different transportation modes based upon the telematics data. For example, speed and/or acceleration can be used to distinguish between modes such as walking, bicycling, or travelling by vehicle. The route can be used to distinguish between, for example, using road transportation versus traveling by railroad. In some embodiments, UMA computing device 102 may utilize machine learning to identify the transportation mode of a trip based upon telematics data.

In some embodiments, UMA computing device 102 may verify the transportation mode with the user. Upon identifying a trip and a mode of transportation associated with the trip, UMA computing device 102 may transmit a verification message to user device 108 and receive a response message from user device 108. User device 108 may display the verification message and receive a response input to the verification message from the user through app 112. For example, upon identifying a train ride, UMA computing device 102 may transmit a verification message to user device 108 asking the user “how was the train ride?” and allowing the user to select between “good,” “OK,” “bad,” or “I did not ride the train.” The user may select a response using app 112. If the user indicates that the user did not ride a train, UMA computing device 102 may, for example, identify a different transportation mode for the trip and/or send another message to the user device asking the user which transportation mode was used.

Verifying the transportation mode enables UMA computing device 102 to improve its ability to identify a transportation mode for a trip, for example, using machine learning. In some embodiments, UMA computing device 102 may verify the identified transportation mode until a threshold amount of trip data has been accumulated. UMA computing device 102 may display, through app 112 on the user device, an amount of progress in accumulating data until verification is no longer necessary. For example, a point may be awarded for each verification message response by the user, and verification messages may no longer be sent to the user once the user has accumulated a certain number of points. The user's current number of points may be displayed in app 112.

In some embodiments, UMA computing device 102 may determine that user device 108 is not being used sufficiently for the accumulated telematics data to accurately reflect the user's transportation behavior. For example, the user may not take user device 108 along with, or may turn user device 108 off, when traveling. User device 108 may display a message indicating, for example, that services associated with UMA computing device 102 (e.g., usage-based insurance) may not be available unless sufficient data is collected.

UMA computing device 102 may analyze trip data for a user to determine an amount of usage of different transportation modes and identify patterns in the user's transportation behavior. In usage-based insurance (UBI), a premium is calculated based at least in part on an insured user's actual transportation behavior. As such, analysis of trip data by UMA computing device 102 may enable an insurer to provide a UBI policy to the user having a premium and coverage that depend on the user's actual transportation behavior. For example, the UMA computing device may retrieve insurance policy data such as a coverage type and a coverage amount, and calculate a premium for the insurance policy based upon the trip data and insurance policy data.

UMA computing device 102 may parse the trip data to identify trips associated with a certain transportation mode (e.g., private automobile or rideshare). UMA computing device 102 may then aggregate the parsed trip data to analyze the user's transportation behavior. For example, UMA computing device 102 may parse the trip data to identify all trips having a particular transportation mode, and aggregate the trips having the same transportation mode to determine, for example, a total amount of time and/or a total mileage for trips having the particular transportation mode.

Determining the total amount of time on trips having the same particular transportation mode enables UMA computing device 102 to determine an insurance premium for a UBI policy, such as a personal mobility policy (PMP). A PMP is a UBI policy that covers a user for multiple forms of personal transportation utilized by the user. For example, a PMP may cover the user for multiple different transportation modes (e.g., rideshares and bike shares). The premium may depend on, for example, an amount of time spent on the different transportation modes (e.g., 10 cents per minute on a bike share). The premium may further depend on the geographic location of the trip (e.g., 10 cents per minute in a suburban area and 20 cents per minute in an urban area). Additionally, the premium may depend on a total number of trips corresponding to the particular transportation mode (e.g., a travel insurance premium based upon a number of airline trips retrieved from a travel website).

UMA computing device 102 may aggregate trip data for a user to identify patterns in the user's transportation behavior. For example, UMA computing device 102 may determine the user's preferred transportation mode for different situations (e.g., different times or locations) by determining the total amount of trips having a particular transportation mode in a particular situation. For example, UMA computing device 102 may determine that the user rides a train to work three days a week and drives the other two days of the week. In some embodiments, UMA computing device 102 may use machine learning to identify patterns in the user's transportation behavior and predict future transportation behavior based upon previous trips. Identifying patterns enables a determination of, for example, an amount of risk associated with the user's transportation behavior. Such a determination may be used by UMA computing device 102 when determining a premium at which to insure the user. For example, UMA computing device 102 may calculate a discounted premium for a user that engages in safer transportation behavior.

In some embodiments, UMA computing device 102 may calculate a score corresponding to the amount of risk associated with the user's transportation behavior (e.g., a score that is higher for safer transportation behavior). The score may correspond to a particular trip or be calculated across all the trips taken by the user. For example, the score for each trip may be aggregated into a cumulative score. A user achieving a certain cumulative score may earn prizes (e.g., in-app recognition such as a badge) to incentivize safer transportation behavior. UMA computing device 102 may determine that the user has earned such a prize based upon the calculated score. For example, a prize may be earned if the score is above a threshold score or the score falls within a certain percentile with respect to scores of other users.

UMA computing device 102 may be configured to provide a user interface enabling the user to interact with UMA computing device 102 (e.g., using user device 108). For example, UMA computing device 102 may provide app 112 that can display messages generated by UMA computing device 102, enable the user to submit messages and/or other input to UMA computing device 102, and/or view information provided by UMA computing device 102.

In some embodiments, the user interface may allow the user to view information about their transportation behavior generated by UMA computing device 102. For example, the user may view charts, tables, or graphs breaking down the user's transportation behavior using app 112.

In some embodiments, the user interface may enable the user to view information about or make changes to the user's insurance policies. For example, in certain embodiments, the user may activate or deactivate insurance policies, set rules under which insurance policies will automatically activate or deactivate (e.g., geographic zones where policies are activated), and/or make changes to coverage types or amounts using app 112. In such embodiments, the user may view the current activation status and/or coverage amount of policies associated with the user.

In some embodiments, UMA computing device 102 may enable a user to make changes to the user's insurance coverage through app 112. For example, a user may activate or deactivate coverage, or change a coverage amount using app 112. Such changes may be preset to automatically occur under certain conditions, such as when the user is in a certain geographic zone.

UMA computing device 102 may receive requests to make a change in insurance coverage. The requests may be generated and transmitted by user device 108 through app 112. The requests may include, for example, requests to activate or deactivate a certain type of insurance coverage or to change the amount of coverage. Such requests may further include requests to set up geography-dependent coverage, such as coverage that is only activated in a certain geographic area or changes amount in a certain geographic area.

UMA computing device 102 may calculate an insurance premium that corresponds to the trip data in the trip database and the amount or type of coverage requested by the user. The coverage can thus be tailored to fit the current needs of the user. For example, a user that only uses rideshares when in a particular city may opt to have a PMP covering rideshares that only becomes active when the user is in the particular city. Because the user does not have PMP coverage outside the particular city, UMA computing device 102 determines the premium based upon trips in trip database 106 that occurred within the particular city.

In another example, a user may desire increased towing coverage (e.g., 400 miles instead of 50 miles) when traveling through a rural area. The user may request, for example, that the towing coverage automatically increase when the user is in a geographic zone associated with the rural area. UMA computing device 102 may then determine that a premium associated with increased towing coverage should be charged only when UMA computing device 102 identifies trips with a location in the rural area (e.g., a route that passes through the rural area).

In some embodiments, UMA computing device 102 may enable, for example an insurance company to provide incentives (e.g., prizes) for engaging in certain transportation behaviors. For example, UMA computing device 102, through the user interface, may provide challenges to users (e.g., riding a bicycle a certain number of miles or a certain number of trips), which may be completed to earn a prize (e.g., an insurance discount, free insurance products or other products, in-app badges). UMA computing device 102 may use trip data in the trip database to determine whether a user has completed a challenge.

UMA computing device 102 may display challenge offer messages including challenge offers via user device 108. The challenge offers may include, for example, a requirement to engage in a certain transportation behavior and a potential prize for completing the challenge. To determine whether a user has met the requirements of the challenge, UMA computing device 102 may retrieve and analyze trip data in trip database 106. For example, to determine that a user has completed a certain number of bicycle trips, UMA computing device 102 may parse the trip data in trip database 106 to identify bicycle trips and count the number of identified trips. In another example, the challenge may be to be in the top 30% of bicycle riders by distance traveled.

To determine whether the challenge has been completed, UMA computing device 102 may calculate an aggregated distance traveled by bike for each user and compare the calculated distances to determine the top 30% of users. If the requirements of the challenge are met, UMA computing device 102 may determine that the user has completed the challenge and user device 108 may display a challenge completion message.

UMA computing device 102 may further be configured to facilitate providing the prize to the user. For example, UMA computing device 102 may determine that a certain insurance product (e.g., roadside assistance) should be provided to the user, or UMA computing device 102 may provide an in-app badge to the user via app 112 that may be shared through social media.

### Exemplary Client Computing Device

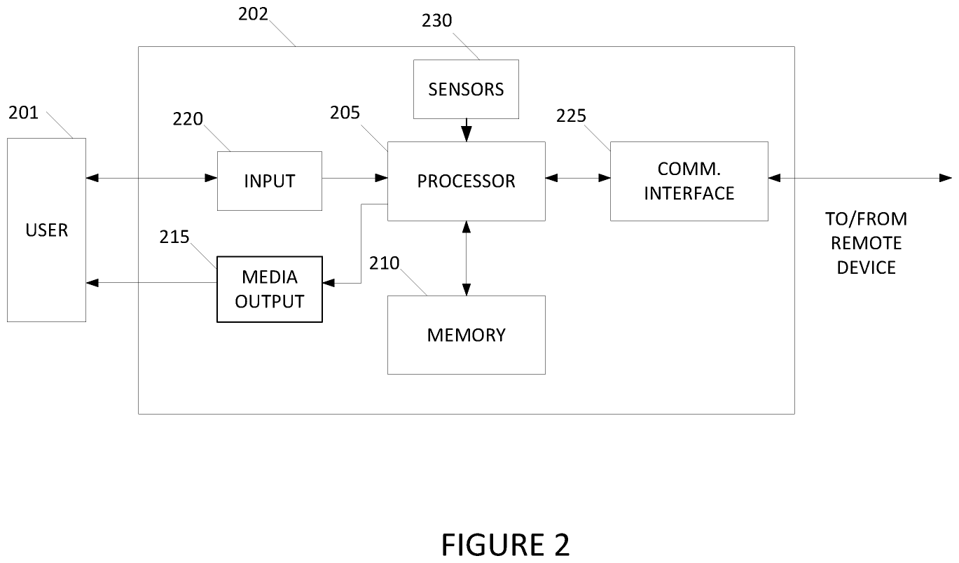

FIG. 2 depicts an exemplary client computing device 202. Client computing device 202 may be, for example, at least one of user device 108 and/or third party computing devices 110 (all shown in FIG. 1).

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In exemplary embodiments, client computing device 202 may also include at least one media output component 215 for presenting information to a user 201. Media output component 215 may be any component capable of conveying information to user 201. In some embodiments, media output component 215 may include an output adapter such as a video adapter and/or an audio adapter. An output adapter may be operatively coupled to processor 205 and operatively couplable to an output device such as a display device (e.g., a liquid crystal display (LCD), light emitting diode (LED) display, organic light emitting diode (OLED) display, cathode ray tube (CRT) display, “electronic ink” display, or a projected display) or an audio output device (e.g., a speaker or headphones).

Client computing device 202 may also include an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

Client computing device 202 may also include a communication interface 225, which can be communicatively coupled to a remote device such as UMA computing device 102 (shown in FIG. 1). Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

In some embodiments, client computing device 202 may also include sensors 230. Sensors 230 may include, for example, an accelerometer, a global positioning system (GPS), or a gyroscope. Sensors 230 may be used to collect telematics data, which may be transmitted by client computing device 202 a remote device such as UMA computing device 102 (shown in FIG. 1).

Stored in memory area 210 may be, for example, computer readable instructions for providing a user interface to user 201 via media output component 215 and, optionally, receiving and processing input from input device 220. A user interface may include, among other possibilities, a web browser and client application. Web browsers may enable users, such as user 201, to display and interact with media and other information typically embedded on a web page or a website. A client application may allow user 201 to interact with a server application from UMA computing device 102 (shown in FIG. 1).

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

### Exemplary Server System

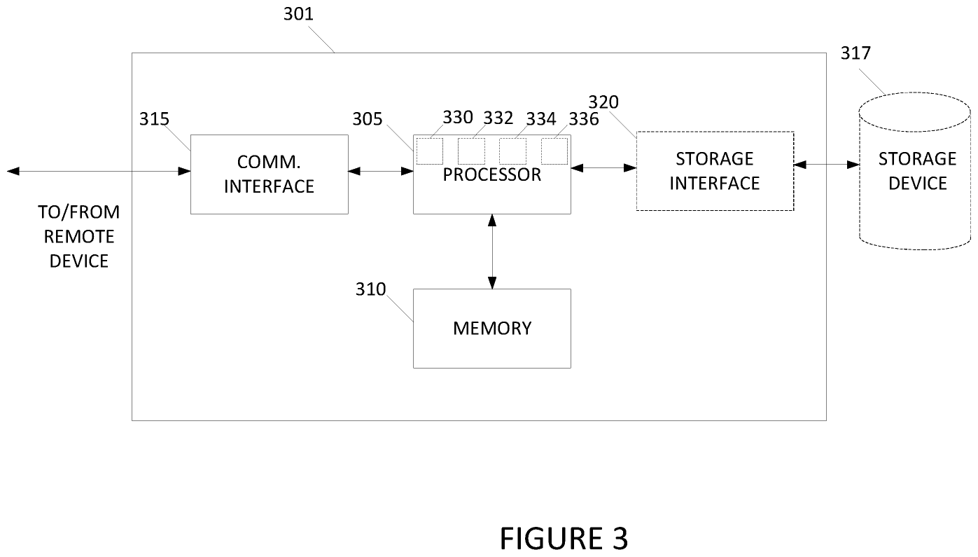

FIG. 3 depicts an exemplary server system that may be used with the UMA analytics system illustrated in FIG. 1. Server system 301 may be, for example, UMA computing device 102 (shown in FIG. 1).

In exemplary embodiments, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

In exemplary embodiments, processor 305 may include and/or be communicatively coupled to one or more modules for implementing the systems and methods described herein. Processor 305 may include a trip identification module 330 for identifying, from telematics data, a plurality of trips of the user and identifying, for each of the plurality of trips, a transportation mode based upon the telematics data. Processor 305 may also include a trip database building module 332 for building a trip database including the plurality of trips and trip data associated with each trip. Processor 305 may also include a trip data aggregating module 334 for parsing the trip data in the database to aggregate trip data associated with a particular transportation mode. Processor 305 may also include a calculating module 336 for calculating an insurance premium based upon the aggregated trip data for a particular transportation mode and insurance policy data.

Processor 305 may be operatively coupled to a communication interface 315 such that server system 301 is capable of communicating with user device 108, third party computing devices 110 (all shown in FIG. 1), or another server system 301. For example, communication interface 315 may receive requests from user device 108 via the Internet.

Processor 305 may also be operatively coupled to a storage device 317, such as database 120 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317.

In other embodiments, storage device 317 may be external to server system 301 and may be accessed by a plurality of server systems 301. For example, storage device 317 may include multiple storage units such as hard disks or solid state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

### Exemplary Method for User Mobility Analytics in a UBI Platform

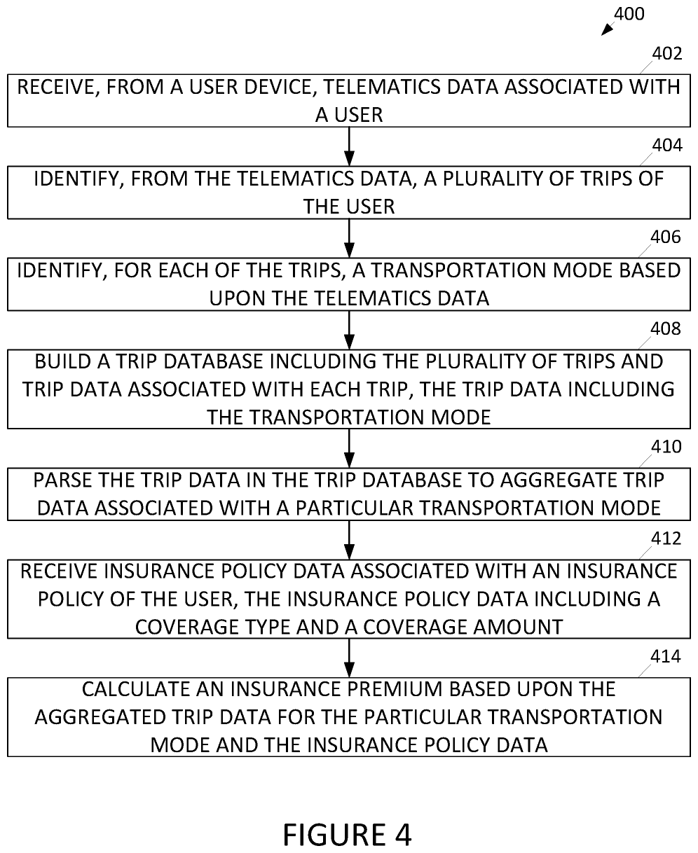

FIG. 4 depicts an exemplary computer-implemented method 400 for user mobility analytics in a usage-based insurance (UBI) platform. Method 400 may be performed, for example, by UMA computing device 102.

Method 400 may include receiving 402, from a user device (and/or one or more vehicles associated with the user), telematics data corresponding to a user.

Method 400 may further include identifying 404, from the telematics data, a plurality of trips of the user. In some embodiments, identifying 404 the plurality of trips may be performed by trip identification module 330 (shown in FIG. 3).

Method 400 may further include identifying 406, for each of the plurality of trips, a transportation mode based upon the telematics data. In certain embodiments, method 400 also includes identifying, for each of the plurality of the trips, at least one geographic location. In some embodiments, identifying 406 the transportation mode may be performed by trip identification module 330 (shown in FIG. 3).

Method 400 may further include building 408 a trip database including the plurality of trips and trip data associated with each trip, the trip data including the transportation mode. In some embodiments, method 400 may also include receiving trip data from a third party computing device and storing the received trip data in the trip database. In some embodiments, building 408 the trip database may be performed by trip database building module 332 (shown in FIG. 3).

Method 400 may further include parsing 410 the trip data in the trip database to aggregate trip data associated with a particular transportation mode. In some embodiments, parsing 410 the trip data may be performed by trip data aggregating module 334 (shown in FIG. 3).

Method 400 may further include retrieving 412 insurance policy data associated with an insurance policy of the user, the insurance policy data including a coverage type and a coverage amount.

Method 400 may further include calculating 414 an insurance premium based upon the aggregated trip data for the particular transportation mode and the insurance policy data. In certain embodiments, method 400 also includes analyzing the trip data to identify a transportation usage pattern. In such embodiments, method 400 may also include calculating the insurance premium based upon the transportation usage pattern. In some embodiments, method 400 also includes calculating a score based upon an amount of risk associated with at least one of the plurality of trips. In some embodiments, calculating 414 the insurance premium may be performed by calculating module 336 (shown in FIG. 3). Method 400 may include additional, less, or alternate actions, including those discussed elsewhere herein.

### Exemplary Method for Verifying a Transportation Mode of a Trip

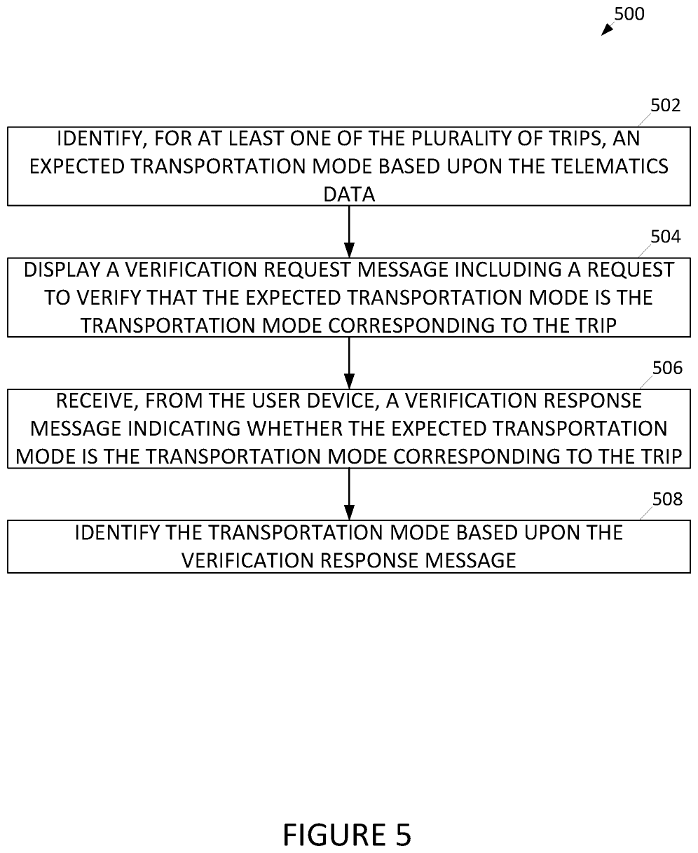

FIG. 5 depicts an exemplary computer-implemented method 500 for verifying a transportation mode of a trip. Method 500 may be performed, for example, by UMA computing device 102. Method 500 may enable UMA computing device 102 to more accurately identify the transportation mode corresponding to a trip.

Method 500 may include identifying 502, for at least one of the plurality of trips, an expected transportation mode based upon the telematics data. Method 500 may include displaying 504 a verification request message including a request to verify that the expected transportation mode is the transportation mode corresponding to the trip. Method 500 may also include receiving 504, from the user device or a vehicle associated with the user, a verification response message indicating whether the expected transportation mode is the transportation mode corresponding to the trip. Method 500 may further include identifying 508 the transportation mode based upon the verification response message. Method 500 may include additional, less, or alternate actions, including those discussed elsewhere herein.

### Exemplary Method of Receiving User Input in a UBI Platform

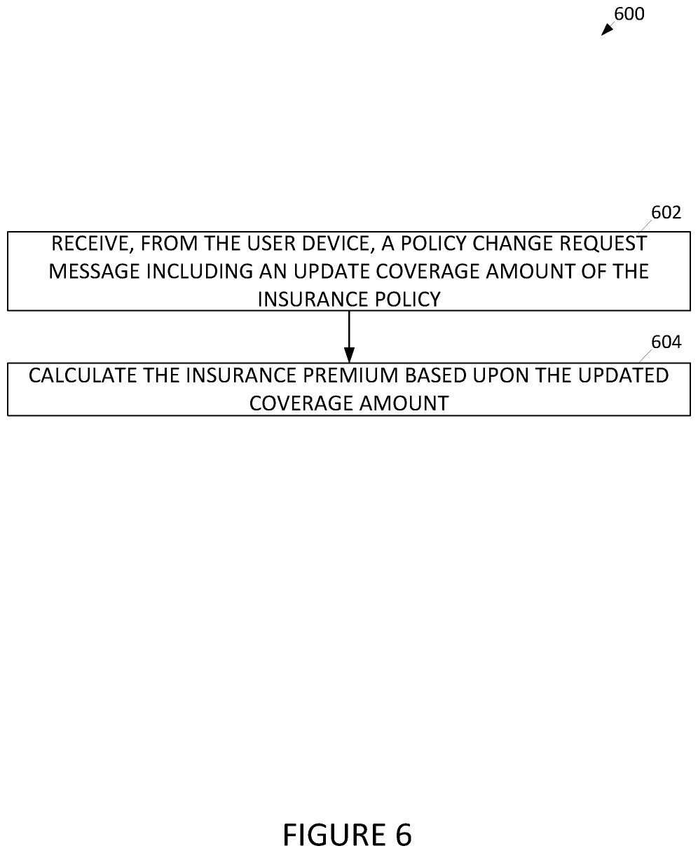

FIG. 6 depicts an exemplary computer-implemented method 600 for receiving user input in an UBI platform. Method 600 may be performed, for example, by UMA computing device 102. Method 600 may enable users to make changes to, for example, coverage in an insurance policy using UMA computing device 102

Method 600 may include receiving 602, from the user device (and/or one or more vehicles associated with the user), a policy change request message including an updated coverage amount of the insurance policy. Method 600 may further include calculating the insurance premium based upon the updated coverage amount. Method 600 may include additional, less, or alternate actions, including those discussed elsewhere herein.

### Exemplary Method Implementing Geographic Location Dependent UBI through a UBI Platform

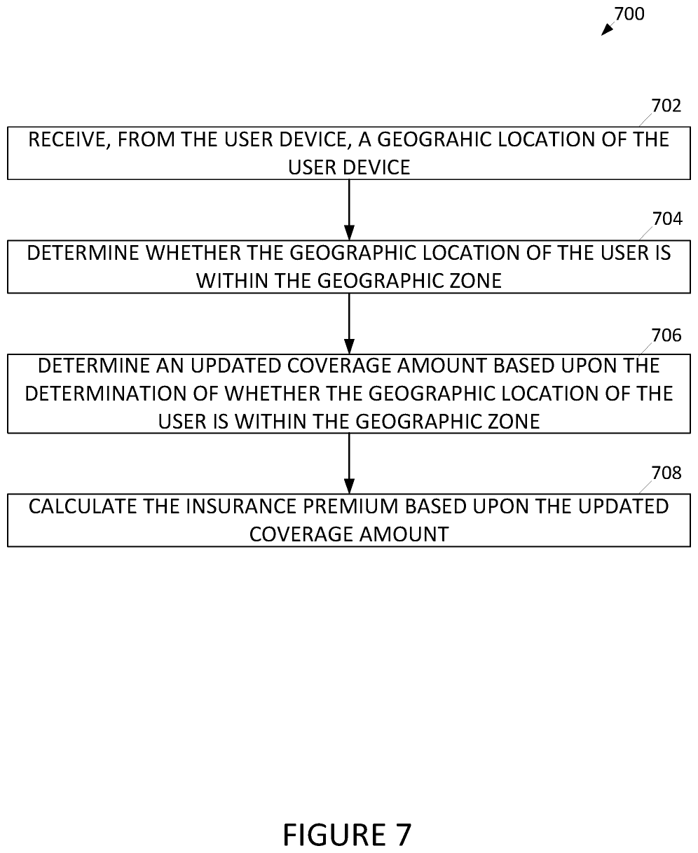

FIG. 7 depicts an exemplary computer-implemented method 700 for implementing geographic location dependent UBI. Method 700 may be performed, for example, by UMA computing device 102.

Method 700 may include receiving 702, from the user device (and/or one or more vehicles associated with the user), a geographic location of the user device. Method 700 may further include determining 704 whether the geographic location of the user device is within a geographic zone included in geographic rules of the policy data. Method 700 may further include determining 706 an updated coverage amount based upon the determination of whether the geographic location of the user device is within the geographic zone. Method 700 may further include calculating 708 the insurance premium based upon the updated coverage amount. Method 700 may include additional, less, or alternate actions, including those discussed elsewhere herein.

### Exemplary Method for Providing and Verifying the Completion of User Challenges within a UBI Platform

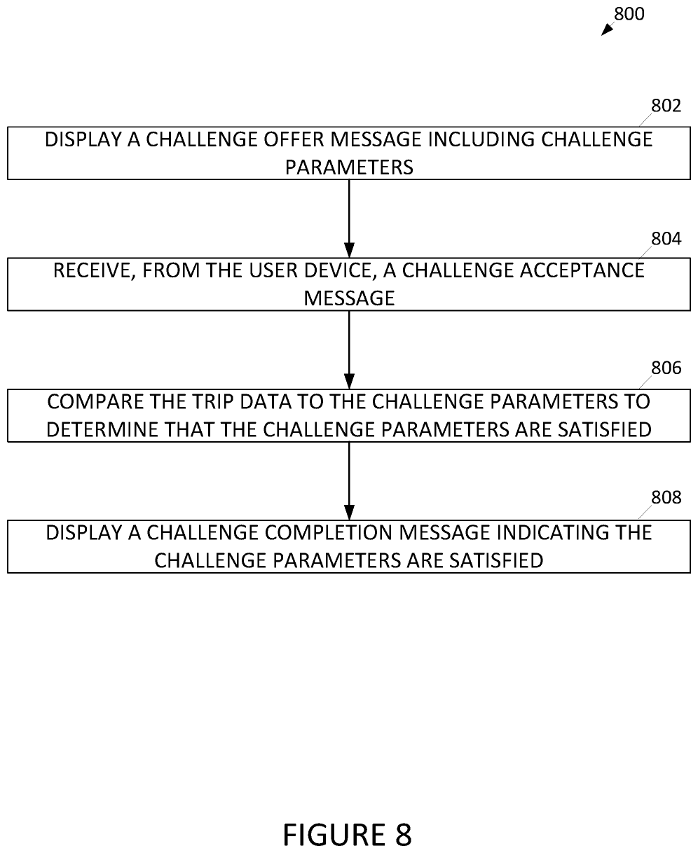

FIG. 8 depicts an exemplary computer-implemented method 800 for providing and verifying the completion of user challenges within a UBI platform. Method 800 may be performed, for example, by UMA computing device 102.

Method 800 may include displaying 802 a challenge offer message including challenge parameters. Method 800 may further include receiving 804, from the user device (and/or one or more vehicles associated with the user), a challenge acceptance message. Method 800 may further include comparing 806 the trip data to the challenge parameters to determine that the challenge parameters are satisfied. Method 800 may further include displaying 808 a challenge completion message indicating the challenge parameters are satisfied. Method 800 may include additional, less, or alternate actions, including those discussed elsewhere herein.

### Exemplary Method for Activating and Deactivating a UBI Policy using a UBI Platform

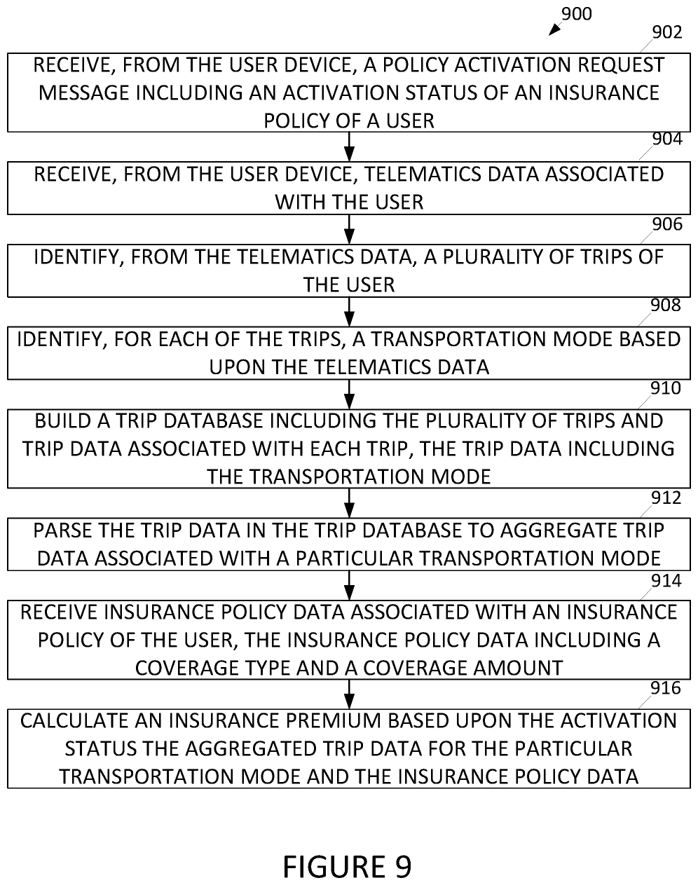

FIG. 9 depicts an exemplary computer-implemented method 900 for activating and deactivating a UBI policy using a UBI platform. Method 900 may be performed, for example, by UMA computing device 102.

Method 900 may include receiving 902, from the user device or a vehicle associated with the user, a policy activation request message including an activation status of an insurance policy of a user.

Method 900 may include receiving 904, from a user device (and/or one or more vehicles associated with the user, such as automobiles or bikes), telematics data corresponding to a user.

Method 900 may further include identifying 906, from the telematics data, a plurality of trips of the user. In some embodiments, identifying 906 the plurality of trips may be performed by trip identification module 330 (shown in FIG. 3).

Method 900 may further include identifying 908, for each of the plurality of trips, a transportation mode based upon the telematics data. In certain embodiments, method 900 also includes identifying, for each of the plurality of the trips, at least one geographic location. In some embodiments, identifying 908 the transportation mode may be performed by trip identification module 330 (shown in FIG. 3).

Method 900 may further include building 910 a trip database including the plurality of trips and trip data associated with each trip, the trip data including the transportation mode. In some embodiments, method 900 may also include receiving trip data from a third party computing device and storing the received trip data in the trip database. In some embodiments, building 910 the trip database may be performed by trip database building module 332 (shown in FIG. 3).

Method 900 may further include parsing 912 the trip data in the trip database to aggregate trip data associated with a particular transportation mode. In some embodiments, parsing 912 the trip data may be performed by trip data aggregating module 334 (shown in FIG. 3).

Method 900 may further include retrieving 914 insurance policy data associated with an insurance policy of the user, the insurance policy data including a coverage type and a coverage amount.

Method 900 may further include calculating 916 an insurance premium based upon the activation status and the aggregated trip data for the particular transportation mode and the insurance policy data. In certain embodiments, method 900 also includes analyzing the trip data to identify a transportation usage pattern. In such embodiments, method 900 may also include calculating the insurance premium based upon the transportation usage pattern. In some embodiments, method 900 also includes calculating a score based upon an amount of risk associated with at least one of the plurality of trips. In some embodiments, calculating 916 the insurance premium may be performed by calculating module 336 (shown in FIG. 3). Method 900 may include additional, less, or alternate actions, including those discussed elsewhere herein.

### Exemplary Method for Activating and Deactivating a UBI Policy Using a UBI Platform

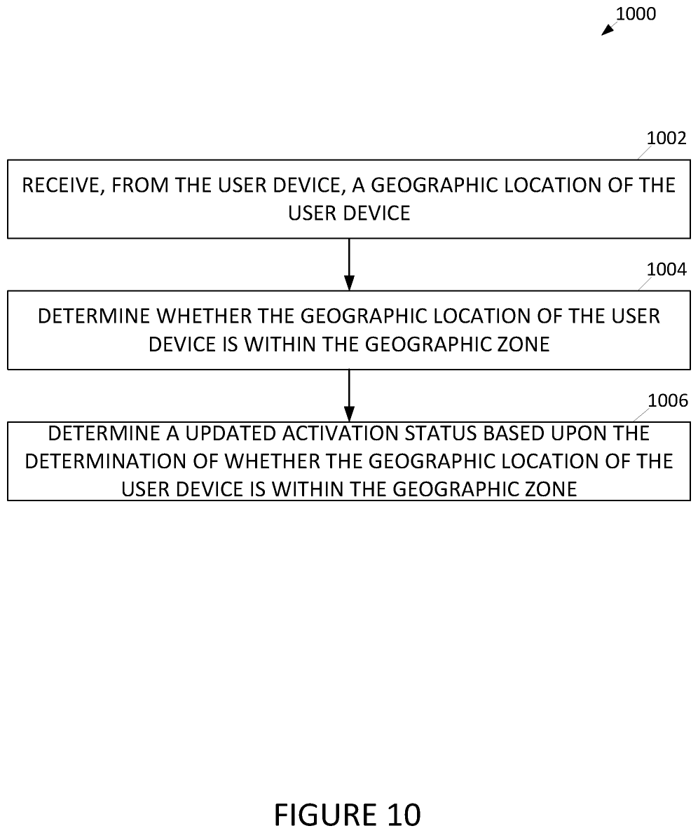

FIG. 10 depicts an exemplary computer-implemented method 1000 for automatically activating and deactivating a UBI policy based upon a geographic location. Method 900 may be performed, for example, by UMA computing device 102.

Method 1000 may include receiving 1002, from the user device (and/or one or more vehicles associated with the user), a geographic location of the user device. Method 1000 may further include determining 1004 whether the geographic location of the user device is within a geographic zone included in geographic rules of the policy data. Method 1000 may further include determining 1006 an updated activation status based upon the determination of whether the geographic location of the user device is within the geographic zone. Method 1000 may include additional, less, or alternate actions, including those discussed elsewhere herein.

### Machine Learning and other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics and information, historical estimates, and/or actual repair costs. The machine learning programs may utilize deep learning algorithms that may be primarily focused on pattern recognition, and may be trained after processing multiple examples. The machine learning programs may include Bayesian program learning (BPL), reinforced learning techniques, voice recognition and synthesis, image or object recognition, optical character recognition, and/or natural language processing—either individually or in combination. The machine learning programs may also include natural language processing, semantic analysis, automatic reasoning, and/or other types of machine learning or artificial intelligence.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

As described above, the systems and methods described herein may use machine learning, for example, for pattern recognition. That is, machine learning algorithms may be used by the UMA computing device to attempt to identify patterns within telematics data and trip data. Further, machine learning algorithms may be used by the UMA computing device to predict a user's future transportation behavior based upon the patterns and likely outcomes associated with the user's future transportation behavior. Accordingly, the systems and methods described herein may use machine learning algorithms for both pattern recognition and predictive modeling.

### Exemplary Embodiments

In one aspect, a user mobility analytics (UMA) computing device including at least one processor in communication with a memory device is provided. The processor may be configured to: (1) receive, from a user device, telematics data corresponding to a user; (2) identify, from the telematics data, a plurality of trips of the user; (3) identify, for each of the plurality of trips, a transportation mode based upon the telematics data; (4) build a trip database including the plurality of trips and trip data associated with each trip, the trip data including the transportation mode; (5) parse the trip data in the trip database to aggregate trip data associated with a particular transportation mode; (6) retrieve insurance policy data associated with an insurance policy of the user, the insurance policy data including a coverage type and a coverage amount; and/or (7) calculate an insurance premium based upon the aggregated trip data for the particular transportation mode and the insurance policy data. The UMA computing device may include additional, less, or alternate functionality, including that discussed elsewhere herein.

In some embodiments, the processor may be further configured to: receive trip data from a third party computing device; and store the received trip data in the trip database.

In some embodiments, the processor may be further configured to identify, for each of the plurality of trips, at least one geographic location, wherein the trip data further includes the at least one geographic location.

In some embodiments, to calculate the insurance premium, the processor may be configured to calculate the insurance premium based upon the at least one geographic location.

In some embodiments, the processor may be further configured to: identify, for at least one of the plurality of trips, an expected transportation mode based upon the telematics data; display a verification request message including a request to verify that the expected transportation mode is the transportation mode corresponding to the trip; receive, from the user device, a verification response message indicating whether the expected transportation mode is the transportation mode corresponding to the trip; and identify the transportation mode based upon the verification response message.

In some embodiments, the processor may be further configured to: receive, from the user device, a policy change request message including an updated coverage amount of the insurance policy; and calculate the insurance premium based upon the updated coverage amount.

In some embodiments, the insurance policy data may include geographic rules, the geographic rules including a geographic zone and a geography dependent coverage amount associated with the geographic zone, and the processor may be further configured to receive, from the user device, a geographic location of the user device; determine whether the geographic location of the user device is within the geographic zone; determine an updated coverage amount based upon the determination of whether the geographic location of the user device is within the geographic zone; and calculate the insurance premium based upon the updated coverage amount.

In some embodiments, the processor may be further configured to: display a challenge offer message including challenge parameters; receive, from the user device, a challenge acceptance message; compare the trip data to the challenge parameters to determine that the challenge parameters are satisfied; and display a challenge completion message indicating the challenge parameters are satisfied.

In some embodiments, the processor may be further configured to analyze the trip data to identify a transportation usage pattern.

In some embodiments, the processor may be further configured to calculate the insurance premium based upon the transportation usage pattern.

In some embodiments, the processor may be further configured to calculate a score based upon an amount of risk associated with at least one of the plurality of trips.

In another aspect, a computer-implemented method for user mobility analytics is provided. The computer-implemented method may be performed by a user mobility analytics (UMA) computing device that includes at least one processor in communication with a memory device. The computer-implemented method may include: (1) receiving, by the UMA computing device, from a user device, telematics data corresponding to a user; (2) identifying, by the UMA computing device, from the telematics data, a plurality of trips of the user; (3) identifying, by the UMA computing device, for each of the plurality of trips, a transportation mode based upon the telematics data; (4) building, by the UMA computing device, a trip database including the plurality of trips and trip data associated with each trip, the trip data including the transportation mode; (5) parsing, by the UMA computing device, the trip data in the trip database to aggregate trip data associated with a particular transportation mode; (6) retrieving, by the UMA computing device, insurance policy data associated with an insurance policy of the user, the insurance policy data including a coverage type and a coverage amount; and/or (7) calculating, by the UMA computing device, an insurance premium based upon the aggregated trip data for the particular transportation mode and the insurance policy data. The computer-implemented method may include additional, less, or alternate actions, including that discussed elsewhere herein.

In some embodiments, the computer-implemented method may further include: receiving, by the UMA computing device, trip data from a third party computing device; and storing, by the UMA computing device, the received trip data in the trip database.

In some embodiments, the computer-implemented method may further include: identifying, by the UMA computing device, for each of the plurality of trips, at least one geographic location, wherein the trip data further includes the at least one geographic location.

In some embodiments, calculating the insurance premium includes calculating, by the UMA computing device, the insurance premium based upon the at least one geographic location.

In some embodiments, the computer-implemented method may further include: identifying, by the UMA computing device, for at least one of the plurality of trips, an expected transportation mode based upon the telematics data; displaying, by the UMA computing device, a verification request message including a request to verify that the expected transportation mode is the transportation mode corresponding to the trip; receiving, by the UMA computing device, from the user device, a verification response message indicating whether the expected transportation mode is the transportation mode corresponding to the trip; and identifying, by the UMA computing device the transportation mode based upon the verification response message.

In some embodiments, the computer-implemented method may further include: receiving, by the UMA computing device, from the user device, a policy change request message including an updated coverage amount of the insurance policy; and calculating, by the UMA computing device, the insurance premium based upon the updated coverage amount.

In some embodiments, the insurance policy data includes geographic rules, the geographic rules including a geographic zone and a geography dependent coverage amount associated with the geographic zone, and the computer-implemented method further includes: receiving, by the UMA computing device, from the user device, a geographic location of the user device; determining, by the UMA computing device, whether the geographic location of the user device is within the geographic zone; determining, by the UMA computing device, an updated coverage amount based upon the determination of whether the geographic location of the user device is within the geographic zone; and calculating, by the UMA computing device, the insurance premium based upon the updated coverage amount.

In some embodiments, the computer-implemented method further includes: displaying, by the UMA computing device, a challenge offer message including challenge parameters; receiving, by the UMA computing device, from the user device, a challenge acceptance message; comparing, by the UMA computing device, the trip data to the challenge parameters to determine that the challenge parameters are satisfied; and displaying, by the UMA computing device, a challenge completion message indicating the challenge parameters are satisfied.

In some embodiments, the computer-implemented method further includes analyzing, by the UMA computing device, the trip data to identify a transportation usage pattern.

In some embodiments, the computer-implemented method further includes calculating, by the UMA computing device, the insurance premium based upon the transportation usage pattern.

In some embodiments, the computer-implemented method further includes, comprising calculating, by the UMA computing device, a score based upon an amount of risk associated with at least one of the plurality of trips.

In another aspect, a non-transitory computer-readable media having computer-executable instructions embodied thereon is provided that, when executed by a user mobility analytics (UMA) computing device including a processor in communication with a memory device, may cause the processor to: (1) receive, from a user device, telematics data corresponding to a user; (2) identify, from the telematics data, a plurality of trips of the user; (3) identify, for each of the plurality of trips, a transportation mode based upon the telematics data; (4) build a trip database including the plurality of trips and trip data associated with each trip, the trip data including the transportation mode; (5) parse the trip data in the trip database to aggregate trip data associated with a particular transportation mode; (6) retrieve insurance policy data associated with an insurance policy of the user, the insurance policy data including a coverage type and a coverage amount; and/or (7) calculate an insurance premium based upon the aggregated trip data for the particular transportation mode and the insurance policy data. The instructions may direct additional, less, or alternate functionality, including that discussed elsewhere herein.

In some embodiments, the computer-executable instructions may further cause the processor to: receive trip data from a third party computing device; and store the received trip data in the trip database.

In some embodiments, the computer-executable instructions may further cause the processor to identify, for each of the plurality of trips, at least one geographic location, wherein the trip data further includes the at least one geographic location.

In some embodiments wherein to calculate the insurance premium, the computer-executable instructions may further cause the processor to calculate the insurance premium based upon the at least one geographic location.

In some embodiments, the computer-executable instructions may further cause the processor to: identify, for at least one of the plurality of trips, an expected transportation mode based upon the telematics data; display a verification request message including a request to verify that the expected transportation mode is the transportation mode corresponding to the trip; receive, from the user device, a verification response message indicating whether the expected transportation mode is the transportation mode corresponding to the trip; and identify the transportation mode based upon the verification response message.

In some embodiments, the computer-executable instructions may further cause the processor to: receive, from the user device, a policy change request message including an updated coverage amount of the insurance policy; and calculate the insurance premium based upon the updated coverage amount.

In some embodiments, the insurance policy data may include geographic rules, the geographic rules including a geographic zone and a geography dependent coverage amount associated with the geographic zone, and the computer-executable instructions may further cause the processor to: receive, from the user device, a geographic location of the user device; determine whether the geographic location of the user device is within the geographic zone; determine an updated coverage amount based upon the determination of whether the geographic location of the user device is within the geographic zone; and calculate the insurance premium based upon the updated coverage amount.

In some embodiments, the computer-executable instructions may further cause the processor to: display a challenge offer message including challenge parameters; receive, from the user device, a challenge acceptance message; compare the trip data to the challenge parameters to determine that the challenge parameters are satisfied; and display a challenge completion message indicating the challenge parameters are satisfied.

In some embodiments, the computer-executable instructions may further cause the processor to analyze the trip data to identify a transportation usage pattern.

In some embodiments, the computer-executable instructions may further cause the processor to calculate the insurance premium based upon the transportation usage pattern.

In some embodiments, the computer-executable instructions may further cause the processor to calculate a score based upon an amount of risk associated with at least one of the plurality of trips.

In another aspect, a user mobility analytics (UMA) computing device including at least one processor in communication with a memory device is provided. The processor may be configured to: (1) receive, from a user device, a policy activation request message including an activation status of an insurance policy of a user; (2) receive, from a user device, telematics data corresponding to the user; (3) identify, from the telematics data, a plurality of trips of the user; (4) identify, for each of the plurality of trips, a transportation mode based upon the telematics data; (5) build a trip database including the plurality of trips and trip data associated with each trip, the trip data including the transportation mode; (6) parse the trip data in the trip database to aggregate trip data associated with a particular transportation mode; (7) retrieve insurance policy data associated with the insurance policy of the user, the insurance policy data including a coverage type and a coverage amount; and/or (8) calculate an insurance premium based upon the activation status and the aggregated trip data for the particular transportation mode and the insurance policy data. The UMA computing device may include additional, less, or alternate functionality, including that discussed elsewhere herein.

In some embodiments, the insurance policy data may include geographic rules, the geographic rules including a geographic zone, and the processor may be further configured to: receive, from the user device, a geographic location of the user device; determine whether the geographic location of the user device is within the geographic zone; and determine an updated activation status based upon the determination of whether the geographic location of the user device is within the geographic zone.

In some embodiments, the processor may be further configured to: receive trip data from a third party computing device; and store the received trip data in the trip database.

In some embodiments, the processor may further be configured to identify, for each of the plurality of trips, at least one geographic location, wherein the trip data further includes the at least one geographic location.

In some embodiments, to calculate the insurance premium, the processor may be configured to calculate the insurance premium based upon the at least one geographic location.

In some embodiments, the processor may be further configured to: identify, for at least one of the plurality of trips, an expected transportation mode based upon the telematics data; display a verification request message including a request to verify that the expected transportation mode is the transportation mode corresponding to the trip; receive, from the user device, a verification response message indicating whether the expected transportation mode is the transportation mode corresponding to the trip; and identify the transportation mode based upon the verification response message.

In some embodiments, the processor may be further configured to: receive, from the user device, a policy change request message including an updated coverage amount of the insurance policy; and calculate the insurance premium based upon the updated coverage amount.

In some embodiments, the insurance policy data may include geographic rules, the geographic rules including a geographic zone and a geography dependent coverage amount associated with the geographic zone, and the processor may be further configured to: receive, from the user device, a geographic location of the user device; determine whether the geographic location of the user device is within the geographic zone; determine an updated coverage amount based upon the determination of whether the geographic location of the user device is within the geographic zone; and calculate the insurance premium based upon the updated coverage amount.

In some embodiments, the processor may be further configured to: display a challenge offer message including challenge parameters; receive, from the user device, a challenge acceptance message; compare the trip data to the challenge parameters to determine that the challenge parameters are satisfied; and display a challenge completion message indicating the challenge parameters are satisfied.

In some embodiments, the processor may be further configured to analyze the trip data to identify a transportation usage pattern.

In some embodiments, the processor may be further configured to calculate the insurance premium based upon the transportation usage pattern.

In some embodiments, wherein the processor may be further configured to calculate a score based upon an amount of risk associated with at least one of the plurality of trips.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computing device comprising a processor in communication with a memory device and a user device, the user device including a plurality of sensors onboard configured to generate telematics data including location data, the processor configured to:
wirelessly receive telematics data from the user device, the user device having an app executing thereon configured to facilitate (i) collection of the telematics data including location data using one or more of the plurality of sensors, and (ii) wireless transmission of the telematics data to the computing device;
identify, based upon the telematics data, a plurality of trips of the user over a period of time;
determine, for each of the plurality of trips, at least one transportation mode based upon the telematics data and stored pattern data;
determine, for each of the plurality of trips by applying predefined rules stored in the memory device, an activation status of a third-party service based upon the (i) the at least one transportation mode associated with the trip and (ii) location data associated with the trip;
build a trip database including the plurality of trips and trip data associated with each of the plurality of trips, the trip data including the transportation mode and the activation status associated with each trip; and
provide data to the user device configured to cause the app to display the trip data associated with at least one trip of the plurality of trips including (i) the at least one transportation mode and (ii) the activation status associated with the at least one trip.

2. The computing device of claim 1, wherein the processor is further configured to:
retrieve one or more geographic rules defining a geographic zone;
determine, based upon the location data, whether a geographic location of the user device is within the geographic zone for a trip of the plurality of trips; and
determine the activation status associated with the trip based upon whether the geographic location of the user device is within the geographic zone for the trip.

3. The computing device of claim 1, wherein the processor is further configured to:
receive trip data from a third party computing device; and
store the received trip data in the trip database.

4. The computing device of claim 1, wherein the processor is further configured to:
identify, for at least one of the plurality of trips, an expected transportation mode based upon the telematics data;
cause the user device to display a verification request message including a request to verify that the expected transportation mode is the transportation mode corresponding to the trip;
receive, from the user device, a verification response message indicating whether the expected transportation mode is the transportation mode corresponding to the trip; and
identify the transportation mode based upon the verification response message.

5. The computing device of claim 1, wherein the third-party service corresponds to an insurance coverage, and wherein the processor is further configured to:
parse the trip data in the trip database to aggregate trip data associated with trips having a particular transportation mode and an active activation status;
determine a transportation usage pattern based upon the aggregated trip data by applying at least one machine learning algorithm to the aggregated trip data; and
calculate an insurance premium based at least in part upon the transportation usage pattern.

6. The computing device of claim 5, wherein the aggregated trip data includes location data, and wherein the processor is further configured to calculate the insurance premium based upon the location data.

7. The computing device of claim 1, wherein the processor is further configured to:
provide data configured to cause the app to display a user interface prompting input of one or more parameters for determining the activation status; and
determine the activation status for each trip of the plurality of trips based further on the one or more parameters.

8. The computing device of claim 7, wherein the one or more parameters includes a geographic location.

9. The computing device of claim 1, wherein the processor is further configured to generate the stored pattern data by applying at least one machine learning algorithm to identify patterns within telematics data.

10. The computing device of claim 1, wherein the processor is further configured to provide additional data to the user device configured to cause the app to display a table including (i) the at least one transportation mode, (ii) a total distance associated with the at least one transportation mode; and (iii) a total time associated with the at least one transportation mode.

11. A computer-implemented method performed by a computing device including a processor in communication with a memory device and a user device, the user device including a plurality of sensors onboard configured to generate telematics data including location data, the method comprising:
wirelessly receiving, by the computing device, telematics data from the user device, the user device having an app executing thereon configured to facilitate (i) collection of the telematics data including location data using one or more of the plurality of sensors, and (ii) wireless transmission of the telematics data to the computing device;
identifying, by the computing device, based upon the telematics data, a plurality of trips of the user over a period of time;
determining, by the computing device, for each of the plurality of trips, at least one transportation mode based upon the telematics data and stored pattern data;
determining, by the computing device, for each of the plurality of trips by applying predefined rules stored in the memory device, an activation status of a third-party service based upon the (i) the at least one transportation mode associated with the trip and (ii) location data associated with the trip;
building, by the computing device, a trip database including the plurality of trips and trip data associated with each of the plurality of trips, the trip data including the transportation mode and the activation status associated with each trip; and
providing, by the computing device, data to the user device configured to cause the app to display the trip data associated with at least one trip of the plurality of trips including (i) the at least one transportation mode and (ii) the activation status associated with the at least one trip.

12. The computer-implemented method of claim 11, further comprising:
retrieving, by the computing device, one or more geographic rules defining a geographic zone;
determining, by the computing device, based upon the location data, whether a geographic location of the user device is within the geographic zone for a trip of the plurality of trips; and
determining, by the computing device, the activation status associated with the trip based upon whether the geographic location of the user device is within the geographic zone for the trip.

13. The computer-implemented method of claim 11, further comprising:
receiving, by the computing device, trip data from a third party computing device; and
storing, by the computing device, the received trip data in the trip database.

14. The computer-implemented method of claim 11, further comprising:
identifying, by the computing device, for at least one of the plurality of trips, an expected transportation mode based upon the telematics data;
causing, by the computing device, the user device to display a verification request message including a request to verify that the expected transportation mode is the transportation mode corresponding to the trip;
receiving, by the computing device, from the user device, a verification response message indicating whether the expected transportation mode is the transportation mode corresponding to the trip; and
identifying, by the computing device, the transportation mode based upon the verification response message.

15. The computer-implemented method of claim 11, further comprising:
providing, by the computing device, data configured to cause the app to display a user interface prompting input of one or more parameters for determining the activation status; and
determining, by the computing device, the activation status for each trip of the plurality of trips based further on the one or more parameters.

16. The computer-implemented method of claim 15, wherein the one or more parameters includes a geographic location.

17. At least one non-transitory computer readable media having computer-executable instructions embodied thereon, wherein when executed by a computing device comprising a processor in communication with a memory device and a user device, the user device including a plurality of sensors onboard configured to generate telematics data including location data, the computer-executable instructions cause the processor to:
wirelessly receive telematics data from the user device, the user device having an app executing thereon configured to facilitate (i) collection of the telematics data including location data using one or more of the plurality of sensors, and (ii) wireless transmission of the telematics data to the computing device;
identify, based upon the telematics data, a plurality of trips of the user over a period of time;
determine, for each of the plurality of trips, at least one transportation mode based upon the telematics data and stored pattern data;
determine, for each of the plurality of trips by applying predefined rules stored in the memory device, an activation status of a third-party service based upon the (i) the at least one transportation mode associated with the trip and (ii) location data associated with the trip;
build a trip database including the plurality of trips and trip data associated with each of the plurality of trips, the trip data including the transportation mode and the activation status associated with each trip; and
provide data to the user device configured to cause the app to display the trip data associated with at least one trip of the plurality of trips including (i) the at least one transportation mode and (ii) the activation status associated with the at least one trip.

18. The at least one non-transitory computer-readable media of claim 17, wherein the computer-executable instructions further cause the processor to:
retrieve one or more geographic rules defining a geographic zone;
determine, based upon the location data, whether a geographic location of the user device is within the geographic zone for a trip of the plurality of trips; and
determine the activation status associated with the trip based upon whether the geographic location of the user device is within the geographic zone for the trip.

19. The at least one non-transitory computer-readable media of claim 17, wherein the computer-executable instructions further cause the processor to:
receive trip data from a third party computing device; and
store the received trip data in the trip database.

20. The at least one non-transitory computer-readable media of claim 17, wherein the computer-executable instructions further cause the processor to:
identify, for at least one of the plurality of trips, an expected transportation mode based upon the telematics data;
cause the user device to display a verification request message including a request to verify that the expected transportation mode is the transportation mode corresponding to the trip;
receive, from the user device, a verification response message indicating whether the expected transportation mode is the transportation mode corresponding to the trip; and
identify the transportation mode based upon the verification response message.
